(19) United States
(12) Patent Application Publication
(10) Pub. No.: US 2013/0224324 A1
(43) Pub. Date: Aug. 29, 2013

(54) SEALANT-ATTACHED TEMPLATE, METHOD FOR STORING TEMPLATE, TEMPLATE SEALING APPARATUS, AND TEMPLATE UNSEALING APPARATUS

(71) Applicant: Yoshihito KOBAYASHI, Tokyo (JP)

(72) Inventor: Yoshihito KOBAYASHI, Tokyo (JP)

(21) Appl. No.: 13/586,987

(22) Filed: Aug. 16, 2012

(30) Foreign Application Priority Data
Feb. 23, 2012 (JP) 2012-037072

(51) Int. Cl. B29C 59/00; B32B 38/10; B32B 37/02

(52) U.S. Cl. 425/385; 156/60; 156/247; 156/538; 156/750

(57) ABSTRACT

A sealant-attached template includes a template, a sealing substrate, and a sealing resin. The template has a major surface and a pattern including at least one of a depression and a protrusion provided on the major surface. The sealing substrate is provided opposite to the pattern of the template. The sealing resin is provided between the major surface and the sealing substrate.

### CROSS-REFERENCE TO RELATED APPLICATIONS

This application is based upon and claims the benefit of priority from the prior Japanese Patent Application No.2012-037072, filed on Feb. 23, 2012; the entire contents of which are incorporated herein by reference.

### FIELD

Embodiments described herein relate generally to sealant-attached template, method for storing template, template sealing apparatus, and template unsealing apparatus.

### BACKGROUND

Recently, there has been proposed a method for forming a fine pattern on a substrate such as a wafer by using the so-called imprint method. In this method, a template having a fine unevenness pattern on the surface is prepared. The unevenness pattern of the template is brought into close contact with the surface of a transfer target such as a resist formed on the wafer. In this state, the transfer target is cured. Then, the template is stripped. Thus, the shape of the unevenness pattern of the template is transferred to the surface of the transfer target.

In such an imprint method, the unevenness pattern of the template is directly transferred. Thus, the presence of foreign matter on the template causes pattern defects. Hence, strict control over foreign matter on the template is required.

### BRIEF DESCRIPTION OF THE DRAWINGS

FIG. 1 is a schematic sectional view illustrating the configuration of a sealant-attached template according to a first embodiment;

FIGS. 2A and 2B are schematic sectional views illustrating the housed state of the template in a storage case;

FIG. 3 is a schematic sectional view illustrating the configuration of a sealant-attached template according to an alternative embodiment;

FIG. 4 is a schematic view illustrating the configuration of a template sealing apparatus according to a second embodiment;

FIGS. 5A to 6B are schematic sectional views illustrating the method for storing a template according to the third embodiment;

FIGS. 7A and 7B are schematic sectional views illustrating the unsealing of the sealant-attached template;

FIGS. 8A to 9B are schematic sectional views illustrating the method for storing a template according to the fourth embodiment; and

FIGS. 10A and 10B are schematic sectional views illustrating the unsealing of the sealant-attached template.

### DETAILED DESCRIPTION

According to one embodiment, a sealant-attached template includes a template, a sealing substrate, and a sealing resin. The template has a major surface and a pattern including at least one of a depression and a protrusion provided on the major surface. The sealing substrate is provided opposite to the pattern of the template. The sealing resin is provided between the major surface and the sealing substrate.

Embodiments of the invention will now be described with reference to the drawings.

The drawings are schematic or conceptual. The relationship between the thickness and the width of each portion, and the size ratio between the portions, for instance, are not necessarily identical to those in reality. Furthermore, the same portion may be shown with different dimensions or ratios depending on the figures.

In the present specification and the drawings, components similar to those described previously with reference to earlier figures are labeled with like reference numerals, and the detailed description thereof is omitted appropriately.

### First Embodiment

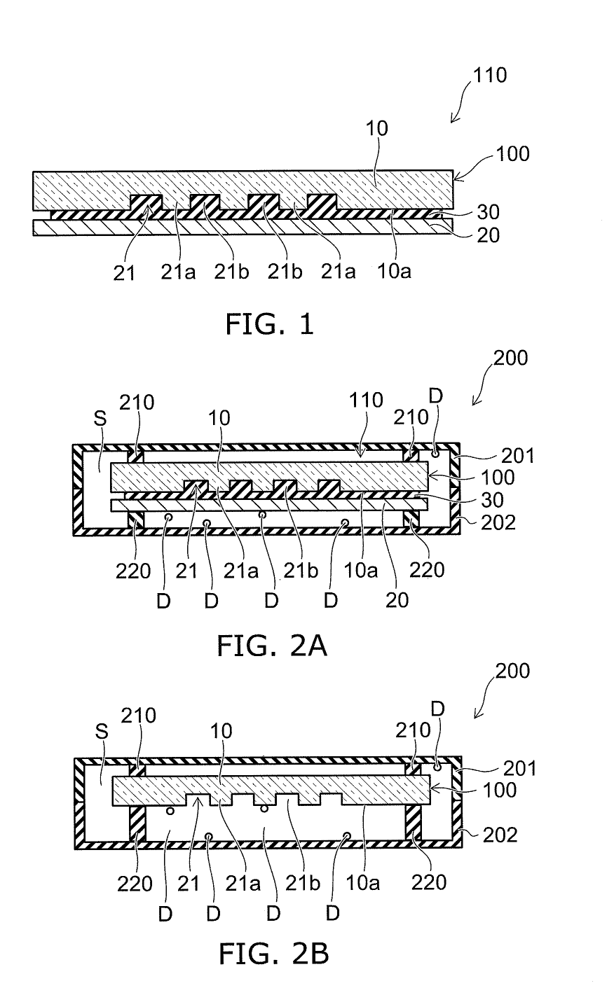

FIG. 1 is a schematic sectional view illustrating the configuration of a sealant-attached template according to a first embodiment.

As shown in FIG. 1, the sealant-attached template 110 according to this embodiment includes a template 100, a sealing substrate 20, and a sealing resin 30.

The template 100 includes a base 10 and a pattern 21. The pattern 21 includes at least one of a depression and a protrusion provided on the major surface 10a of the base 10. The template 100 is an original plate used in transferring the pattern by the imprint method. The base 10 is made of e.g. quartz glass.

The pattern 21 includes e.g. a protrusion 21a and a depression 21b. The protrusion 21a and the depression 21b are provided in e.g. a line shape. The protrusion 21a may be provided in a pillar shape. The depression 21b may be provided in a hole shape. The pattern 21 may be provided integrally with or separately from the base 10.

The sealing substrate 20 is provided opposite to the pattern 21 of the template 100. The sealing substrate 20 is e.g. a glass substrate, a semiconductor (e.g., silicon) substrate, a metal substrate, or a resin substrate. The sealing substrate 20 may be a hard substrate, a flexible substrate, or a film-like substrate. The thickness of the sealing substrate 20 is e.g. several millimeters (mm).

The sealing resin 30 is provided between the major surface 10a and the sealing substrate 20. In the example shown in FIG. 1, the sealing resin 30 is provided between the major surface 10a and the pattern 21 on one hand and the sealing substrate 20 on the other. That is, as viewed in the direction normal to the major surface 10a, the sealing resin 30 is provided on the formation region of the pattern 21 and the other region.

Foreign matter in the sealing resin 30 has been removed beforehand by e.g. a filter. The material of the sealing resin 30 is not particularly limited as long as it is superior in releasability from the template 100. The sealing resin 30 is made of e.g. a photocurable resin cured by ultraviolet (UV) irradiation, or a thermosetting resin cured by heating.

Examples of the photocurable resin include urethane resin, epoxy resin, and acrylic resin. For instance, the photocurable resin can be low-viscosity UV-curable resin HDDA (1,6-hexanediol diacrylate) or HEBDM (bis(hydroxyethyl)bisphenol-A dimethacrylate).

Alternatively, the sealing resin 30 may be a thermosetting resin such as phenol resin, epoxy resin, silicone, and polyimide, or a thermoreversible resin such as poly(methyl methacrylate) (PMMA), polycarbonate (PC), and acrylic resin.

Preferably, the sealing resin 30 is a photocurable resin having high curing rate and being easy to use. In the description of this embodiment, a photocurable resin is used as an example.

The thickness of the sealing resin 30 is e.g. not less than 50 nanometers (nm) and not more than 50 micrometers (μm), and preferably not less than 100 nm and not more than 5 μm. By setting the thickness of the sealing resin 30 to this range, damage to the pattern 21 due to contact between the pattern 21 and the sealing substrate 20 is prevented when the sealing substrate 20 is stuck on the template 100 via the sealing resin 30.

In the sealant-attached template 110 according to this embodiment, the sealing substrate 20 is provided opposite to the pattern 21 of the template 100. Thus, after forming the template 100, attachment of foreign matter to the pattern 21 is prevented. Furthermore, because the pattern 21 is not exposed to the open air, alteration of the pattern 21 is prevented.

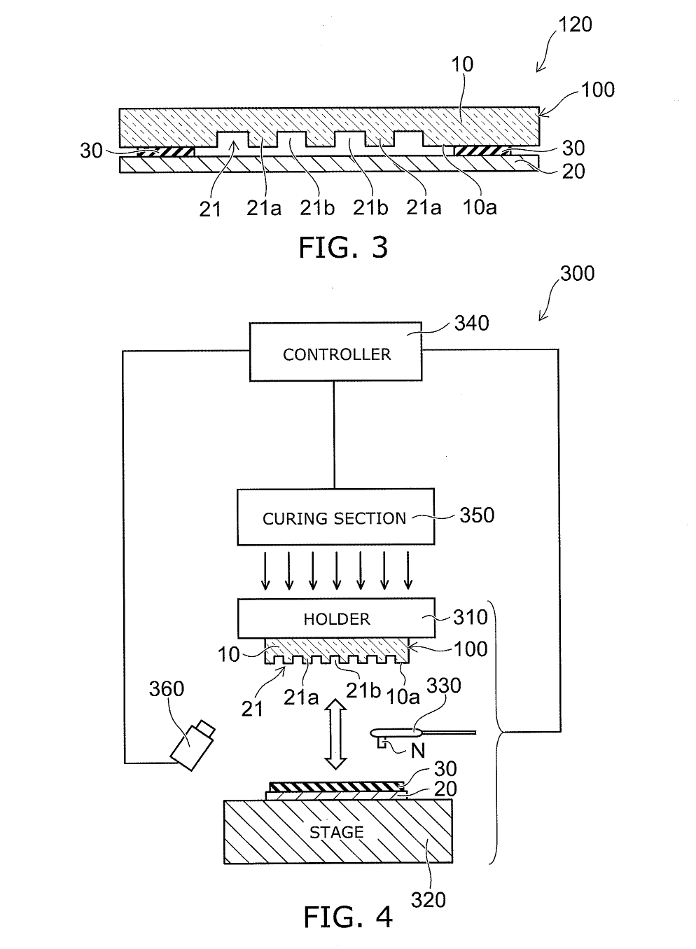

FIGS. 2A and 2B are schematic sectional views illustrating the housed state of the template in a storage case.

FIG. 2A shows the housed state of the sealant-attached template 110 according to this embodiment. FIG. 2B shows the housed state of a template 100 according to a reference example.

As shown in FIGS. 2A and 2B, the storage case 200 includes e.g. an upper section 201 and a lower section 202. The upper section 201 is stacked on the lower section 202. In the storage case 200, the template 100 is housed in the space S between the upper section 201 and the lower section 202. A strut 210 is provided inside the upper section 201. A strut 220 is provided inside the lower section 202. When the upper section 201 is stacked on the lower section 202, the strut 210 and the strut 220 are opposed to each other.

As shown in FIG. 2A, the sealant-attached template 110 according to this embodiment is sandwiched between the strut 210 and the strut 220 in the space between the upper section 201 and the lower section 202. The sealant-attached template 110 is housed in the storage case 200 by e.g. mounting the sealant-attached template 110 on the strut 220 of the lower section 202 and then stacking the upper section 201 on the lower section 202. The upper section 201 is fixed to the lower section 202 by e.g. fitting. When the upper section 201 is stacked on the lower section 202, the sealant-attached template 110 mounted on the strut 220 is pressed by the strut 210 of the upper section 201. Thus, the sealant-attached template 110 is fixed between the strut 210 and the strut 220 in the space S.

As shown in FIG. 2B, also in housing the template 100 according to the reference example, like the sealant-attached template 110, the template 100 is fixed between the strut 210 and the strut 220 in the space S of the storage case 200.

Here, when the template 100 is formed and then housed in the storage case 200, the template 100 is formed, then cleaned, and then housed in the storage case 200. The storage case 200 is also cleaned before housing the template 100. The template 100 is housed in the storage case 200 during transportation to the imprint, apparatus and until its use.

As shown in FIG. 2B, in the housed state of the template 100 according to the reference example, the pattern 21 of the template 100 is exposed in the space S of the storage case 200. Thus, if foreign matter D remains in the storage case 200, the foreign matter D may be attached to the pattern 21 during storage. Furthermore, the surface of the pattern 21 may be altered.

As shown in FIG. 2A, in the sealant-attached template 110 according to this embodiment, the pattern 21 of the template 100 is covered with the sealing substrate 20. Thus, even if foreign matter D remains in the storage case 200, the foreign matter D is not attached to the pattern 21 during storage. Furthermore, the surface of the pattern 21 is not exposed. Thus, alteration of the surface of the pattern 21 is suppressed.

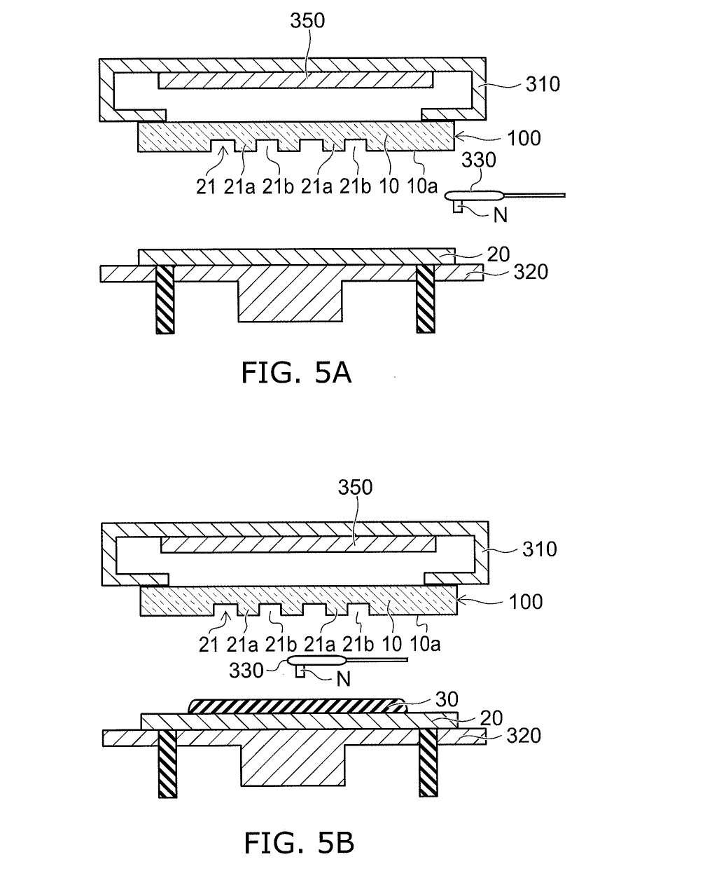

FIG. 3 is a schematic sectional view illustrating the configuration of a sealant-attached template according to an alternative embodiment.

As shown in FIG. 3, in this sealant-attached template 120, as viewed in the direction normal to the major surface 10a, the sealing resin 30 is provided on a region except the formation region of the pattern 21 of the template 100. That is, the sealing resin 30 is not provided on the formation region of the pattern 21 of the template 100.

In the sealant-attached template 120, the sealing substrate 20 is stuck on the template 100 via the sealing resin 30. The sealing resin 30 is not provided on the formation region of the pattern 21. Thus, a gap is provided between the pattern 21 and the sealing substrate 20. Here, the sealing resin 30 is provided so as to surround the formation region of the pattern 21. Thus, the gap between the pattern 21 and the sealing substrate 20 is sealed from the outside.

Like the sealant-attached template 110 described above, the sealant-attached template 120 is also housed in the storage case 200. The pattern 21 is covered with the sealing substrate 20. Thus, even if foreign matter D remains in the storage case 200, the foreign matter D is not attached to the pattern 21 during storage. Furthermore, the gap between the pattern 21 and the sealing substrate 20 is sealed from the outside. Thus, alteration of the surface of the pattern 21 is suppressed. In the sealant-attached template 120, the sealing resin 30 is not in contact with the pattern 21. Thus, the influence on the pattern 21 due to contact with the sealing resin 30 is avoided.

In the cured state of the sealing resin 30, the adhesive strength between the sealing resin 30 and the sealing substrate 20 is stronger than the adhesive strength between the sealing resin 30 and the major surface 10a. In the case where the sealing resin 30 is also in contact with the pattern 21, the adhesive strength between the sealing resin 30 and the sealing substrate 20 is stronger than the adhesive strength between the sealing resin 30 on one hand and the major surface 10a and the pattern 21 on the other. Thus, when the sealing substrate 20 is stripped from the template 100, the sealing resin 30 is stripped together with the sealing substrate 20 from the major surface 10a and the pattern 21. When the sealing substrate 20 is stripped, the sealing resin 30 does not remain on the major surface 10a and the pattern 21.

In order for the sealing resin 30 to achieve the adhesive strength as described above, for instance, a release agent may be used.

The release agent can be e.g. a silicone-based release agent, a polyethylene wax, an amide wax, a solid wax such as Teflon powder, a fluorine compound, or a phosphoester compound.

The silicone-based release agent is a release agent whose basic structure is the organo-polysiloxane structure. Examples of the silicone-based release agent include unmodified or modified silicone oil, polysiloxane containing trimethylsiloxysilicate, and silicone-based acrylic resin.

The modified silicone oil is obtained by modifying the side chains and terminals of polysiloxane, and classified into reactive silicone oil and non-reactive silicone oil. The reactive silicone oils include e.g. amino-modified, epoxy-modified, carboxyl-modified, carbinol-modified, methacryl-modified, mercapto-modified, phenol-modified, one-terminal reactive, and heterogeneous functional group-modified silicone oils. The non-reactive silicone oils include e.g. polyether-modified, methylstyryl-modified, alkyl-modified, higher fatty acid ester-modified, hydrophilic special-modified, higher alkoxy-modified, higher fatty acid-modified, and fluorine-modified silicone oils. One polysiloxane molecule may be subjected to two or more of the modification methods as described above.

Preferably, the modified silicone oil has moderate compatibility with the composition components.

The release agent may be made of only one kind, or a combination of two or more kinds.

The added amount of the release agent is preferably in the proportion of 0.001-10% by mass, and more preferably in the proportion of 0.01-5% by mass, to the total amount of the composition.

### Second Embodiment

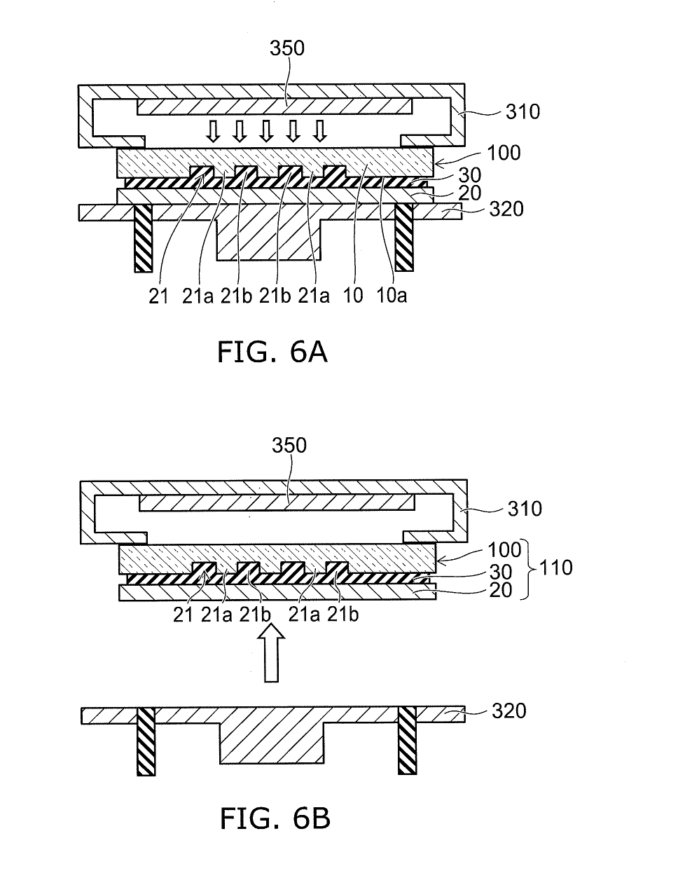

FIG. 4 is a schematic view illustrating the configuration of a template sealing apparatus according to a second embodiment.

As shown in FIG. 4, the template sealing apparatus 300 according to this embodiment includes a holder 310, a stage 320, an applicator 330, and a controller 340.

The holder 310 includes a mechanism for holding a template 100. For instance, the holder 310 sucks and holds the template 100 by vacuum suction.

The stage 320 serves to mount a sealing substrate 20. For instance, the stage 320 sucks and holds the sealing substrate 20 by vacuum suction.

The applicator 330 includes a mechanism for applying a sealing resin 30 onto the sealing substrate 20. The applicator 330 is provided with e.g. a nozzle N. From the nozzle N, the sealing resin 30 is jetted toward the sealing substrate 20. The nozzle N is retractably provided above the sealing substrate 20.

The controller 340 controls the position of at least one of the holder 310 and the stage 320 so that the major surface 10a of the template 100 is brought into contact with the sealing resin 30. That is, at least one of the holder 310 and the stage 320 is provided with a vertical movement mechanism. By controlling this movement mechanism, the controller 340 adjusts the spacing between the holder 310 and the stage 320.

Furthermore, the template sealing apparatus 300 includes a curing section 350 for curing the sealing resin 30. In the case where the sealing resin 30 is a photocurable resin, the curing section 350 is a light irradiation device. In the case where the sealing resin 30 is a thermosetting resin, the curing section 350 is a hot plate or infrared irradiation device. With the template 100 and the sealing resin 30 being in contact with each other, the template sealing apparatus 300 cures the sealing resin 30 by the curing section 350.

The template sealing apparatus 300 may include an image capture section 360. The image capture section 360 captures an image of the pattern 21 of the template 100 held on the holder 310. The captured image is sent to the controller 340. The controller 340 may analyze the image of the pattern 21 to perform foreign matter inspection of the pattern 21.

The template sealing apparatus 300 according to this embodiment may double as an imprint apparatus for forming a pattern using the template 100. Furthermore, an image capture section 360 may be provided as described above. Thus, the template sealing apparatus 300 may have the function of performing foreign matter inspection by the controller 340. Accordingly, the template sealing apparatus 300 may function as a foreign matter inspection apparatus for the pattern 21. Furthermore, the template sealing apparatus 300 may be incorporated in a foreign matter inspection apparatus for the pattern 21.

In the above example, the sealing resin 30 is supplied to the sealing substrate 20 side. Alternatively, the sealing resin 30 may be supplied to the template 100 side to stick the sealing substrate 20 on the template 100.

### Third Embodiment

Next, a method for storing a template according to a third embodiment is described. The method for storing a template according to this embodiment uses the template sealing apparatus 300 according to the second embodiment.

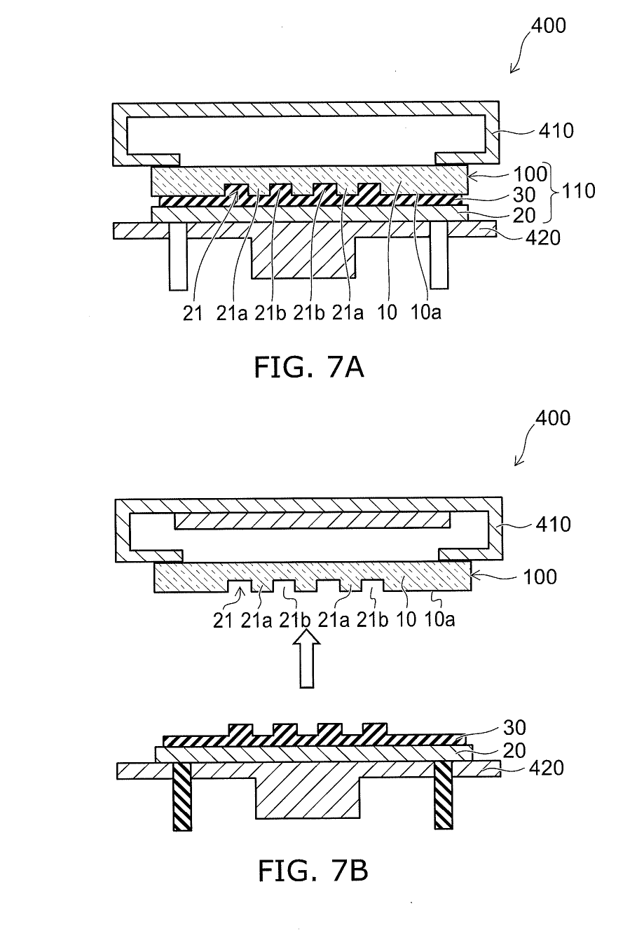

FIGS. 5A to 6B are schematic sectional views illustrating the method for storing a template according to the third embodiment.

First, as shown in FIG. 5A, a sealing substrate 20 is mounted on the stage 320. A template 100 is held by the holder 310. The sealing substrate 20 and the template 100 may be each transported by a transport unit, not shown. The sealing substrate 20 is fixed onto the stage 320 by e.g. vacuum suction. The template 100 is fixed to the holder 310 by e.g. vacuum suction.

Next, as shown in FIG. 5B, the nozzle N, for instance, of the applicator 330 is extended to above the sealing substrate 20. From the nozzle N, a sealing resin 30 is applied onto the sealing substrate 20. As a method for supplying the sealing resin 30, for instance, the ink jet method is typically used. However, the method is not particularly limited.

Next, as shown in FIG. 6A, the template 100 is brought into contact with the sealing resin 30. More specifically, after the sealing resin 30 is supplied onto the sealing substrate 20, at least one of the holder 310 of the template 100 and the stage 320 of the sealing substrate 20 is moved. Thus, the template 100 and the sealing resin 30 are brought into close contact with each other.

Next, in this state, the sealing resin 30 is cured by the curing section 350. In the case where the sealing resin 30 is a photocurable resin, the curing section 350 is a light irradiation device. In the case where the sealing resin 30 is a thermosetting resin, the curing section 350 is a hot plate or infrared irradiation device. The curing method is not limited to the foregoing.

Here, the state of curing of the sealing resin 30 is represented by e.g. curing ratio. The curing ratio is a value representing the degree of progress of curing. The state in which curing no longer proceeds is defined as 100%. The state in which no curing has proceeded is defined as 0%. In this embodiment, the curing ratio of the sealing resin 30 is set to the range of e.g. not less than 30% and not more than 100%, and preferably not less than 50% and not more than 100%.

Next, as shown in FIG. 6B, after curing the sealing resin 30, fixing of the sealing substrate 20 to the stage 320 is disengaged. At least one of the holder 310 of the template 100 and the stage 320 is moved to release the sealing substrate 20 from the stage 320. This completes a sealant-attached template 110 in which the sealing substrate 20 is fixed to the template 100 via the sealing resin 30.

The sealant-attached template 110 is transported by a transport unit, not shown, and housed in the storage case 200 shown in FIG. 2A. The sealant-attached template 110 is stored in the state of being hermetically sealed in the storage case 200. The sealant-attached template 110 is stored in the state of being housed in the storage case 200 while being transported from the storage location to the imprint apparatus for performing imprint. That is, the template 100 is stored in the storage case 200 from the completion of the sealant-attached template 110 until use for imprint.

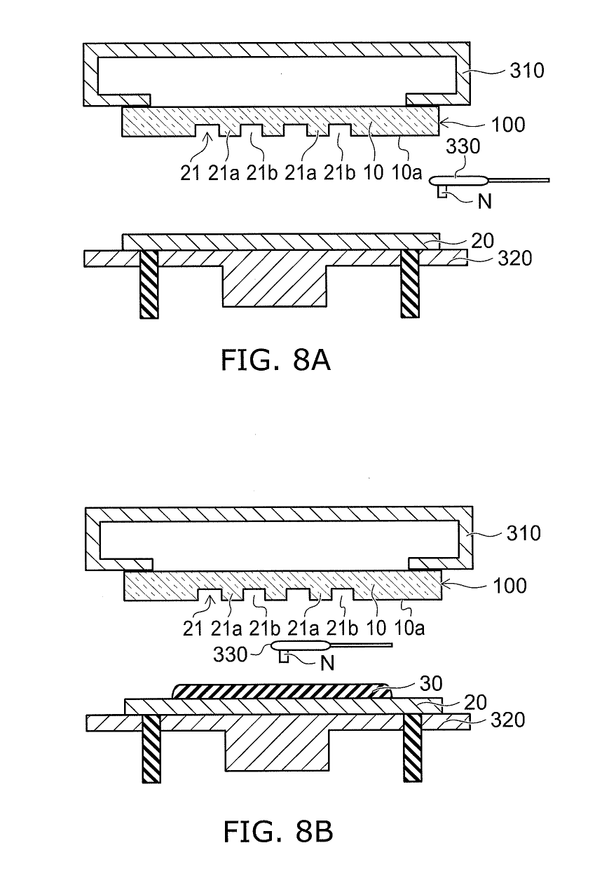

FIGS. 7A and 7B are schematic sectional views illustrating the unsealing of the sealant-attached template.

FIGS. 7A and 7B show an unsealing apparatus 400. The unsealing apparatus 400 includes a holder 410 for the sealant-attached template 110 and a stage 420 for the sealing substrate 20. Furthermore, the unsealing apparatus 400 includes a moving mechanism (not shown) for at least one of the holder 410 and the stage 420.

The unsealing apparatus 400 shown in FIGS. 7A and 7B may be an independent apparatus, or an apparatus doubling as the template sealing apparatus 300 or an imprint apparatus.

Before using the template 100, this unsealing apparatus 400 is used to detach the sealing substrate 20 from the template 100. The detachment of the sealing substrate 20 from the template 100 is referred to as unsealing of the template 100.

First, the sealant-attached template 110 is transported by a transport unit, not shown, and fixed to the holder 410. Fixing of the sealant-attached template 110 to the holder 410 is performed by e.g. vacuum suction. Next, at least one of the holder 410 and the stage 420 is moved. Thus, the sealing substrate 20 is brought into close contact with and fixed to the stage 420. Fixing of the sealing substrate 20 to the stage 420 is performed by e.g. vacuum suction.

Next, as shown in FIG. 7B, with the sealant-attached template 110 fixed to the holder 410 and the stage 420, at least one of the holder 410 and the stage 420 is moved. Thus, the sealing substrate 20 is detached from the template 100.

Here, the adhesive strength between the sealing resin 30 and the sealing substrate 20 is stronger than the adhesive strength between the sealing resin 30 and the template 100 (the adhesive strength between the sealing resin 30 and the template 100 is weaker than the adhesive strength between the sealing resin 30 and the sealing substrate 20). Thus, stripping occurs at the interface between the template 100 and the sealing resin 30. Hence, with the sealing resin 30 attached to the sealing substrate 20, the sealing substrate 20 is stripped from the template 100.

That is, the template 100 is fixed to the holder 410 side, and the sealing substrate 20 attached with the sealing resin 30 is fixed to the stage 420 side. In this state, the template 100 is separated from the sealing substrate 20. Thus, the template 100 is unsealed.

After unsealing, the template 100 and the sealing substrate 20 are each transported by a transport unit (not shown). The template 100 is used for imprint by an imprint apparatus.

By the method for storing the template 100 as described above, after the template 100 is formed, attachment of foreign matter D to the pattern 21 during storage and transportation of the template 100, and alteration of the pattern 21, are reliably prevented. This improves the defect yield of pattern formation by imprint using the template 100.

In the above embodiments, in forming the sealant-attached template 110, the sealing resin 30 is cured. However, the sealing resin 30 does not need to be fully cured, but may be placed in a semi-cured state.

Semi-curing of the sealing resin 30 refers to setting the curing ratio of the sealing resin 30 to the range of e.g. not less than 3% and not more than 100%, and preferably not less than 10% and not more than 50%.

Thus, the load on the sealant-attached template 110 due to e.g. vibration during transportation is absorbed by the sealing resin 30. This increases the effect of suppressing e.g. damage to the pattern 21.

In the case where the sealing resin 30 of the sealant-attached template 110 is in the semi-cured state, the template 100 is unsealed after curing the sealing resin 30. Thus, the sealing substrate 20 is easily stripped from the template 100.

### Fourth Embodiment

Next, a method for storing a template according to a fourth embodiment is described. In this embodiment, the template sealing apparatus 300 according to the second embodiment is used as an example.

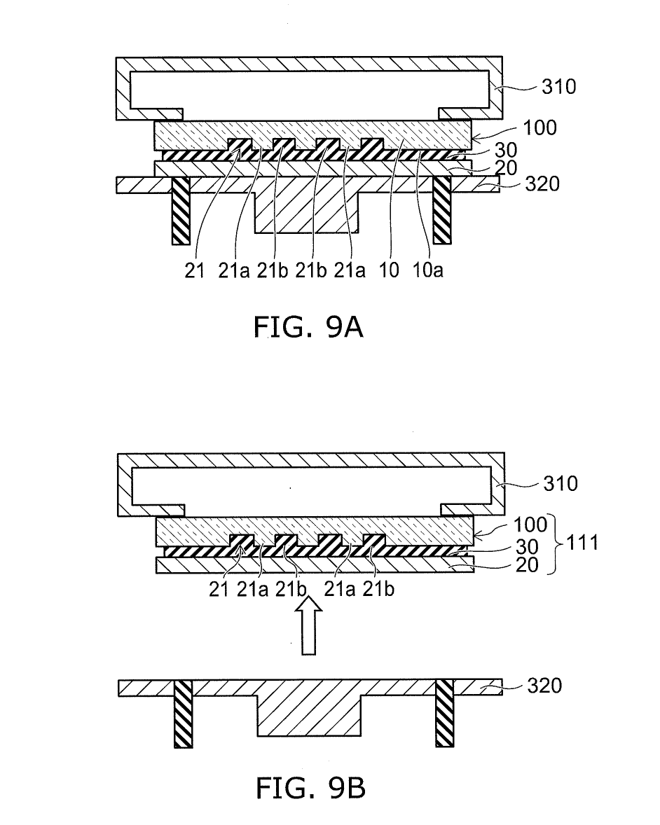

FIGS. 8A to 9B are schematic sectional views illustrating the method for storing a template according to the fourth embodiment.

First, as shown in FIG. 8A, a sealing substrate 20 is mounted on the stage 320. A template 100 is held by the holder 310. The sealing substrate 20 and the template 100 may be each transported by a transport unit, not shown. The sealing substrate 20 is fixed onto the stage 320 by e.g. vacuum suction. The template 100 is fixed to the holder 310 by e.g. vacuum suction.

Next, as shown in FIG. 8B, the nozzle N, for instance, of the applicator 330 is extended to above the sealing substrate 20.

From the nozzle N, a sealing resin 30 is applied onto the sealing substrate 20. As a method for supplying the sealing resin 30, for instance, the ink jet method is typically used. However, the method is not particularly limited.

Next, as shown in FIG. 9A, the template 100 is brought into contact with the sealing resin 30. More specifically, after the sealing resin 30 is supplied onto the sealing substrate 20, at least one of the holder 310 of the template 100 and the stage 320 of the sealing substrate 20 is moved. Thus, the template 100 and the sealing resin 30 are brought into close contact with each other.

Next, as shown in FIG. 9B, with the sealing resin 30 being in the uncured state, fixing of the sealing substrate 20 to the stage 320 is disengaged. At least one of the holder 310 of the template 100 and the stage 320 is moved to release the sealing substrate 20 from the stage 320. Even if the sealing resin 30 is in the uncured state, the sealing substrate 20 is in close contact with the template 100 by surface tension of the sealing resin 30. Thus, even if the sealing substrate 20 is released from the stage 320, the sealing substrate 20 is not stripped from the template 100. This completes a sealant-attached template 111 in which the sealing substrate 20 is stuck on the template 100 via the uncured sealing resin 30. In this embodiment, the uncured state of the sealing resin 30 refers to setting the curing ratio of the sealing resin 30 to the range of e.g. not less than 0% and not more than 20%, and preferably not less than 0% and not more than 10%.

The sealant-attached template 111 is transported by a transport unit, not shown, and housed in the storage case 200 shown in FIG. 2A. The sealant-attached template 111 is stored in the state of being hermetically sealed in the storage case 200. The sealant-attached template 111 is stored in the state of being housed in the storage case 200 while being transported from the storage location to the imprint apparatus for performing imprint. That is, the template 100 is stored in the storage case 200 from the completion of the sealant-attached template 111 until use for imprint.

In forming the sealant-attached template 111, the sealing resin 30 is not cured. Thus, there is no need to use the curing section 350 of the template sealing apparatus 300. Hence, the sealant-attached template 111 may be formed by using a sealing apparatus lacking the curing section 350 of the template sealing apparatus 300.

In the sealant-attached template 111 as described above, the sealing resin 30 is in the uncured state. Thus, load occurring due to e.g. vibration during transportation is absorbed by the sealing resin 30 in the uncured state. Hence, force due to the load is less likely to act on the pattern 21. This suppresses e.g. damage to the pattern 21.

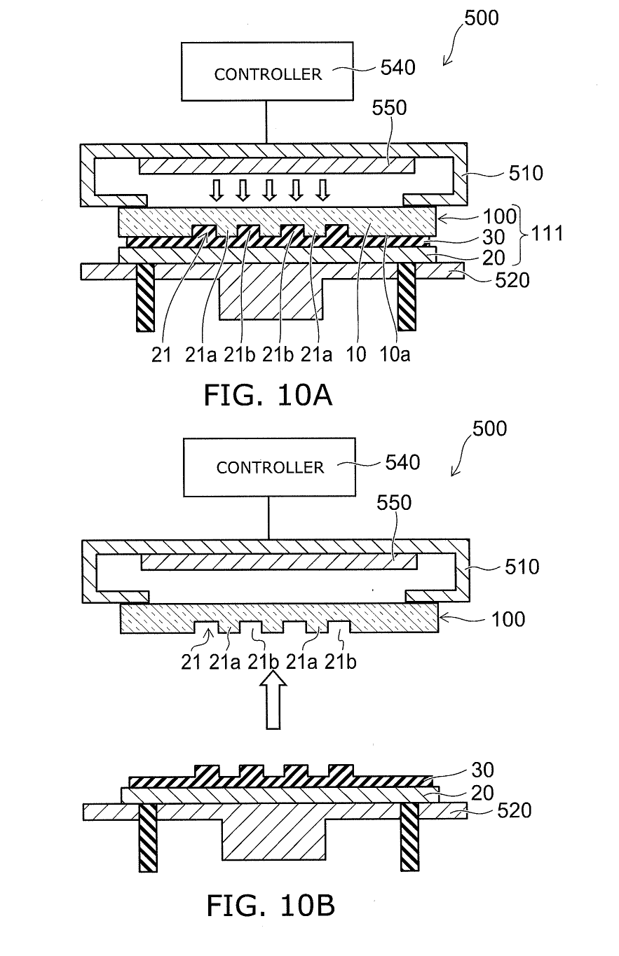

FIGS. 10A and 10B are schematic sectional views illustrating the unsealing of the sealant-attached template.

FIGS. 10A and 10B show an unsealing apparatus 500. The unsealing apparatus 500 includes a stage 520 for holding the sealing substrate 20 side of the sealant-attached template 111, a holder 510 for holding the template 100 side of the sealant-attached template 111, a curing section 550 for curing the sealing resin 30, and a controller 540 for controlling a moving mechanism (not shown) for at least one of the holder 510 and the stage 520.

The unsealing apparatus 500 shown in FIGS. 10A and 10B may be an independent apparatus, or an apparatus doubling as the template sealing apparatus 300 or an imprint apparatus.

Before using the template 100, this unsealing apparatus 500 is used to detach (unseal) the sealing substrate 20 from the template 100.

First, the sealant-attached template 111 is transported by a transport unit, not shown, and fixed to the holder 510. Fixing of the sealant-attached template 111 to the holder 510 is performed by e.g. vacuum suction. Next, under the instruction of the controller 540, at least one of the holder 510 and the stage 520 is moved. Thus, the sealing substrate 20 is brought into close contact with and fixed to the stage 520. Fixing of the sealing substrate 20 to the stage 520 is performed by e.g. vacuum suction.

Next, in this state, the sealing resin 30 is cured by the curing section 550. In the case where the sealing resin 30 is a photocurable resin, the curing section 550 is a light irradiation device. In the case where the sealing resin 30 is a thermosetting resin, the curing section 550 is a hot plate or infrared irradiation device. The curing method is not limited to the foregoing.

Next, as shown in FIG. 10B, with the sealant-attached template 111 fixed to the holder 510 and the stage 520, at least one of the holder 510 and the stage 520 is moved. Thus, the sealing substrate 20 is detached from the template 100.

Here, the adhesive strength between the cured sealing resin 30 and the sealing substrate 20 is stronger than the adhesive strength between the sealing resin 30 and the template 100 (the adhesive strength between the sealing resin 30 and the template 100 is weaker than the adhesive strength between the sealing resin 30 and the sealing substrate 20). Thus, stripping occurs at the interface between the template 100 and the sealing resin 30. Hence, with the sealing resin 30 attached to the sealing substrate 20, the sealing substrate 20 is stripped from the template 100.

That is, the template 100 is fixed to the holder 510 side, and the sealing substrate 20 attached with the sealing resin 30 is fixed to the stage 520 side. In this state, the template 100 is separated from the sealing substrate 20. Thus, the template 100 is unsealed.

After unsealing, the template 100 and the sealing substrate 20 are each transported by a transport unit (not shown). The template 100 is used for imprint by an imprint apparatus.

By the method for storing the template 100 as described above, after the template 100 is formed, attachment of foreign matter D to the pattern 21 during storage and transportation of the template 100, and alteration of the pattern 21, are reliably prevented. This improves the defect yield of pattern formation by imprint using the template 100.

Furthermore, during storage and transportation of the template 100, the sealing resin 30 is in the uncured state. Thus, load applied to the pattern 21 of the template 100 due to e.g. vibration during transportation is absorbed by the sealing resin 30 in the uncured state. This suppresses e.g. damage to the pattern 21.

As described above, the sealant-attached template, the method for storing a template, and the template sealing apparatus according to the embodiments can prevent attachment of foreign matter D to the template.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A sealant-attached template comprising:
a template having a major surface and a pattern including at least one of a depression and a protrusion provided on the major surface;
a sealing substrate provided opposite to the pattern of the template; and
a sealing resin provided between the major surface and the sealing substrate.

2. The template according to claim 1, wherein the sealing resin is provided between a formation region of the pattern and the sealing substrate.

3. The template according to claim 1, wherein the sealing resin is provided between a region except a formation region of the pattern and the sealing substrate.

4. The template according to claim 1, wherein adhesive strength between the sealing resin and the sealing substrate is stronger than adhesive strength between the sealing resin and the major surface.

5. The template according to claim 3, wherein the sealing resin is provided so as to surround the formation region of the pattern.

6. The template according to claim 1, wherein the sealing resin includes a release agent.

7. The template according to claim 1, wherein the sealing resin has a thickness of not less than 50 nanometers and not more than 50 micrometers.

8. The template according to claim 1, wherein the sealing resin has a thickness of not less than 100 nanometers and not more than 5 micrometers.

9. The template according to claim 1, wherein the sealing substrate is flexible.

10. A method for storing a template, comprising:
after forming a template having a major surface and a pattern including at least one of a depression and a protrusion provided on the major surface, attaching a sealing substrate onto the pattern of the template via a sealing resin; and
storing the template attached with the sealing substrate.

11. The method according to claim 10, wherein the storing the template includes housing the template attached with the sealing substrate in a storage case.

12. The method according to claim 10, wherein the attaching a sealing substrate includes:
applying the sealing resin onto the sealing substrate; and
bringing the major surface of the template into contact with the sealing resin.

13. The method according to claim 12, wherein the attaching a sealing substrate further includes:
after the bringing the major surface of the template into contact with the sealing resin, curing the sealing resin.

14. The method according to claim 13, wherein the curing the sealing resin includes setting curing ratio of the sealing resin to not less than 30% and not more than 100%.

15. The method according to claim 13, wherein the curing the sealing resin includes setting curing ratio of the sealing resin to not less than 10% and not more than 50%.

16. The method according to claim 10, wherein
the attaching a sealing substrate includes applying the sealing resin onto the sealing substrate, and
the storing the template includes housing in a storage case the template attached with the sealing substrate with the sealing resin being in an uncured state.

17. The method according to claim 16, further comprising:
after the storing the template, curing the uncured sealing resin; and
detaching the sealing substrate from the template with the sealing resin being in a cured state.

18. A template sealing apparatus comprising:
a holder configured to hold a template, the template having a major surface and a pattern including at least one of a depression and a protrusion provided on the major surface;
a stage configured to mount a sealing substrate;
an applicator configured to apply a sealing resin onto the sealing substrate; and
a controller configured to control a position of at least one of the holder and the stage to bring the major surface of the template into contact with the sealing resin.

19. The apparatus according to claim 18, further comprising:
a curing section configured to cure the sealing resin.

20. A template unsealing apparatus comprising:
a stage configured to hold a sealant-attached template, the sealant-attached template including a template having a pattern, a sealing substrate provided opposite to the pattern of the template, and a sealing resin provided between the template and the sealing substrate, the stage being configured to hold the sealing substrate side of the sealant-attached template;
a holder configured to hold the template side of the sealant-attached template;
a curing section configured to cure the sealing resin; and
a controller configured to control a position of at least one of the holder and the stage to detach the sealing substrate from the template with the sealing resin being in a cured state.
